(19) United States
(12) Patent Application Publication
(10) Pub. No.: US 2009/0319602 A1
(43) Pub. Date: Dec. 24, 2009

(54) MAINTAINING ENTITY COLLABORATION SITES

(75) Inventors: Bradley C. Stevenson, Seattle, WA (US); Howard M. Crow, Sammamish, WA (US); Thomas K. Gersten, Redmond, WA (US); Constantin Stanciu, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/144,395

(22) Filed: Jun. 23, 2008

(51) Int. Cl. G06F 15/16

(52) U.S. Cl. 709/203

(57) ABSTRACT

Logical collaboration sites are structured to simplify creation and subsequent discovery by arranging them hierarchically to reflect entity types. Mapping tables enable quick, direct access to both collaboration sites and to the entity type sites. Persistent state data in client application documents link the documents to associated sites. The collaboration sites can be manipulated from the client applications by leveraging the data in the mapping tables and site structures.

### BACKGROUND

Collaboration spaces are useful for supporting cooperative tasks in which multiple people need to share, modify and review common materials. This is especially true where their physical workplaces are geographically diverse. They are also useful for gathering a diverse set of documents, or links to documents, into a single location, condensing the knowledge contained in scattered references into a single, coherent collection. Collaboration spaces may also be used to support a meeting or series of meetings by providing a single reference location for all of the participants.

Collaboration spaces are typically document or event centric. They are often loosely structured, with little, if any, obvious structure or organization spanning the disparate sites. This lack of organization can cause confusion or added effort when creating the site; can make them difficult to find after they have been created; and may result in duplicate or conflicting information on different sites. Unless given a direct link to a site, some users will be unable to find the correct site by browsing or searching.

A collaboration space which is difficult to establish, find, or use can have a chilling effect on the very effort it is intended to support. Rather than a fluid, dynamic interchange of ideas, the process can become disjointed and frustrating. Information may be lost or not shared because of the difficulties associated with making it available in the correct location.

### SUMMARY

This Summary is provided to introduce in a simplified form a selection of concepts that are further described below in the Detailed Description. This Summary is not intended to identify key features or essential features of the claimed subject matter, nor is it intended to be used to limit the scope of the claimed subject matter.

Various aspects of the subject matter disclosed herein are related to the logical structure of a set of logical collaboration sites. Certain aspects of the structure provide a hierarchical organization of the collaboration sites simplifying the tasks of creating them and accessing them. Other aspects of the structure ease navigation to the sites by linking them from referenced documents and ease navigation between sites by linking related sites.

Other aspects of the present disclosure relate to methods of using the sites by providing functionality in the client software applications enabling access to an associated collaboration site from within a document.

Still other aspects of the disclosure relate to modeling the collaboration sites as being organized around logical entities rather than documents or meetings.

A more complete appreciation of the above summary can be obtained by reference to the accompanying drawings, which are briefly summarized below, to the following detailed description of present embodiments, and to the appended claims.

### BRIEF DESCRIPTION OF THE SEVERAL VIEWS OF THE DRAWINGS

FIG. 1 is a class diagram of the high level structure of the logical components of the present disclosure.

FIG. 2 depicts an exemplary embodiment of an entity type mapping table.

FIG. 3 depicts an exemplary embodiment of an instance mapping table.

FIG. 4 depicts and exemplary embodiment of a client item persistent data table.

FIG. 5 is a high level flow diagram of a process for accessing collaboration sites per the present disclosure.

FIG. 6 is a block diagram of an exemplary hardware architecture

### DETAILED DESCRIPTION

This detailed description is made with reference to the accompanying drawings, which form a part hereof, and which show, by way of illustration, specific exemplary embodiments. These embodiments are described in sufficient detail to enable those skilled in the art to practice what is taught below, and it is to be understood that other embodiments may be utilized and that logical, mechanical, electrical, and other changes may be made without departing from the spirit or scope of the subject matter. The following detailed description is, therefore, not to be taken in a limiting sense, and its scope is defined only by the appended claims.

### Overview

The concepts of the present disclosure relate to the creation and use of a logical collaboration space associated with a business entity. The present disclosure addresses implementing a collaboration space as a structured collaboration site which serves as a repository of related documents along with associated information and functionality.

An exemplary embodiment of these concepts implements the collaboration space as a server based site using a product such as Microsoft® SharePoint® to provide access and underlying functionality. One concept of the present disclosure is that this server based site is directly accessible from remote client applications such as Microsoft® Word or Outlook®). An aspect of this accessibility is that navigation information is stored in or associated with specific documents of the type created by the client applications. This approach enables a user to directly access the collaboration site linked from a document.

### Structure

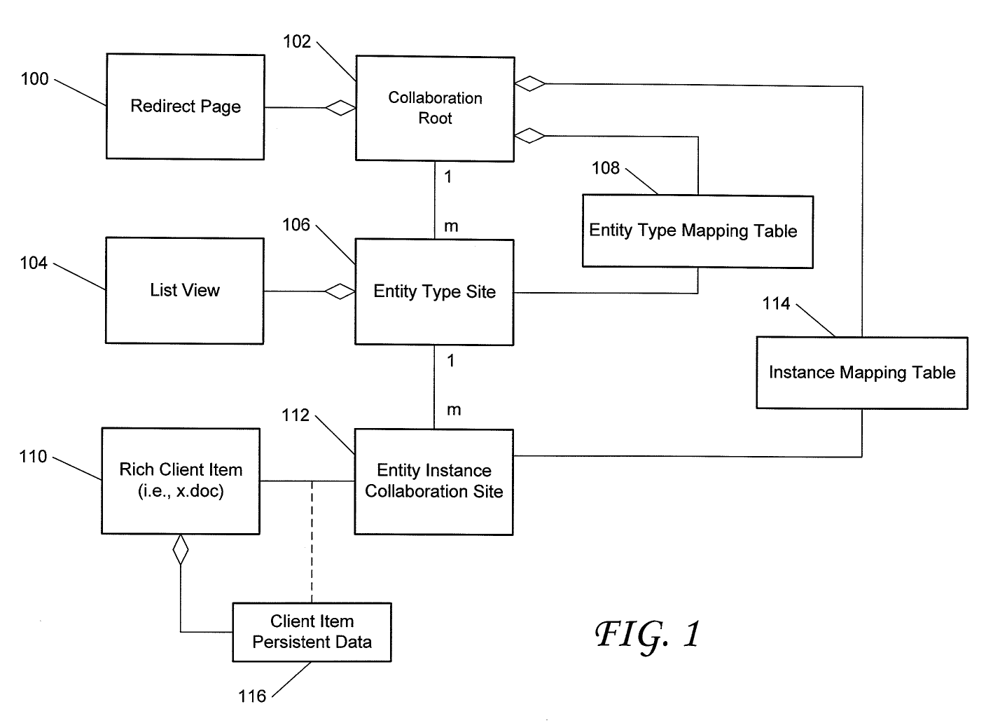

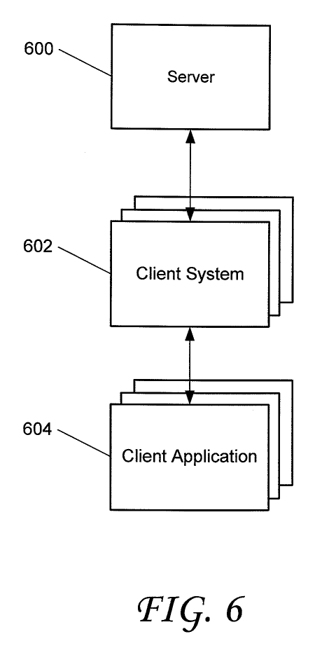

Referring to FIG. 1 the high level logical structure of the components used in an exemplary embodiment of the present disclosure can be seen, presented as a UML class diagram. The collaboration site on the Server 600 comprises a hierarchical organization of three components. FIG. 6 illustrates an exemplary hardware architecture which could be used to host the present disclosure. Each Server 600 typically serves multiple client computer systems 602 and each client system can host multiple client applications 604.

The Collaboration Root 102 (also known as an Office Business Application site) serves as the root node for all components on the Server 600. All associated Entity Type Sites 106 are subsites of the Collaboration Root 102; the two Mapping Tables 108 and 114 are stored in the Collaboration Root 102; and the Redirect Page 100 is hosted on the Collaboration Root 102. The Collaboration Root 102 serves as a “known” location which every client application supporting collaboration sites will know how to locate and access. This allows them to find the Redirect Page 100 and the Mapping Tables 108 and 114 when necessary. In an exemplary embodiment, the Collaboration Root 102 is implemented as a SharePoint® SPSite.

The Entity Type Site 106 (also known as a Business Data Center) is a sub-site to the Collaboration Root 102 and serves as the root for all collaboration sites which are of a particular entity type. Entity types are user definable and are intended to be configured to the business needs of the end customer. In a sales organization an entity type might be Customer, Account, Product, etc. In a human resources organization the relevant entity types might be Position, Job Applicant, Interview, etc. The Entity Type Site 106 also hosts user interface components with provide access to the collaboration sites for one particular entity type. These are also expected to be user definable but an exemplary embodiment would provide basic components such as a List View 104 of all associated collaboration sites. This allows a user of a client application to select a particular entity type and then browse the related collaboration sites to find one of interest.

The Entity Instance Collaboration Site 112 is the collaboration space for a single instance of the defined entity types. For example, where the entity type is Customer, an instance might be “Acme Manufacturing”; where the entity type is “Job Applicant” an instance might be “Jane Doe.” The Entity Instance Collaboration Site 112 is expected to be user definable but an exemplary embodiment would include: descriptive information about the instance (i.e., name, ID number, etc); a collection of links to those client documents (i.e., product list, resume, etc.) which have been associated to the site; a set of user interface components for displaying information about the instance; navigating to associated collaboration sites (i.e., from the “Jane Doe” Job Applicant collaboration site, go to the “Interview” site for one of her interview sessions); and navigating to other Entity Type Sites 106 under the same Collaboration Root 102. This capability is enabled by the mapping tables discussed below. Each contains all of the associated sites which exist under the Collaboration Root 102. Altering or removing filter criteria allows different sites to be displayed.

Two mapping tables are used to support navigation. The Entity Type Mapping Table 108 (also known as BusinessDataCenterToEntityMapping) maintains a list of Entity Type Sites 106 and their addresses. This table is stored in the Collaboration Root 102 allowing it to be easily accessed by the client applications. This enables a user of a client application to readily browse and navigate to an available Entity Type Site 106. Although referred to as “tables” these mapping structures could be implemented as any equivalent data set.

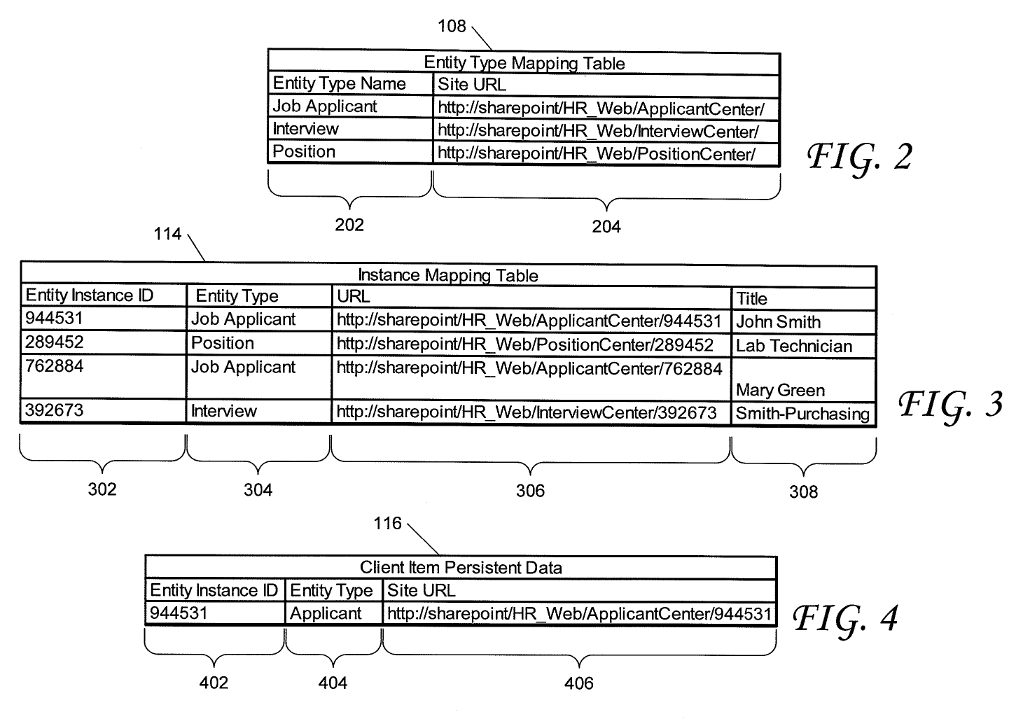

Referring to FIG. 2 a sample Entity Type Mapping Table 108 can be seen. In an exemplary embodiment, Entity Type Site 106 is identified by the Entity Type Name 202, and the address is a Site Uniform Resource Locator (URL) 204 as shown. In the sample data a pattern is used for the URL which matches the URL to the storage structure: http://<host_site>/<collab_root>/<EntityName>Center/. Thus, for a SharePoint hosted Collaboration Root 102 associated with the Human Resources (HR) department, the Entity Type Site 106 for Job Applicants might be http://sharepoint/HR_Web/ApplicantCenter/. Clearly other patterns and other implementations of logical addresses are possible.

The second mapping table is the Instance Mapping Table 114 (also known as a BusinessDataEntityToSiteMapping) which correlates Entity Instances with their Entity Instance Collaboration Site 112. This table is also stored in the Collaboration Root 102 allowing it to be easily accessed by the client applications. This enables a user of a client application to navigate directly to an instance's Entity Instance Collaboration Site 112.

Referring to FIG. 3 a sample Instance Mapping Table 114 can be seen. In an exemplary embodiment, each instance is assigned a unique identity which is used as its Entity Instance ID 302. The table also records the Entity Type 304; URL 306; and a Title 308. In this sample data a similar pattern as that for the Entity Type Mapping Table 108 is used: http://<host_site>/<collab_root>/<EntityName>Center/<Identity>/. Thus, for a SharePoint hosted Collaboration Root 102 associated with the Human Resources (HR) department, an Entity Instance of type “Job Applicant” might be http://sharepoint/HR_Web/ApplicantCenter/944531. Clearly other patterns and other implementations of addresses are possible. Note that the Instance Mapping Table 114 contains all Entity Instance Collaboration Sites 112 under Collaboration Root 102. Filtering this list by entity type allows all Entity Instance Collaboration Sites 112 for a particular entity type to be displayed. Filtering this list by Identity allows all Entity Instance Collaboration Sites 112 for a particular instance to be displayed, regardless of entity type.

Referring again to FIG. 1 the aspects of the logical structure which reside on the client can be seen. A Rich Client Item 110 (i.e., Microsoft Word Document) maintains Client Item Persistent Data 116 which maintains the relationship between the Rich Client Item 110 and the associated Entity Instance Collaboration Site, or sites, 112. This allows the user to navigate directly to an Entity Instance Collaboration Site 112 with minimal interaction. An exemplary embodiment stores this data within the document. An alternative embodiment stores this data on the computer on which the client application is running, logically linked to the client document.

Referring to FIG. 4, example Client Item Persistent Data 116 can be seen. Each related Entity Instance Collaboration Site 112 is represented by a single record (represented as a row in this exemplary embodiment) comprising an Entity Instance ID 404; Entity Type 402; and Site URL 406.

In addition to these client side structures, an exemplary embodiment will provide user interface elements on the client to allow the user to navigate to an associated site, and establish and remove these associations.

### Operation

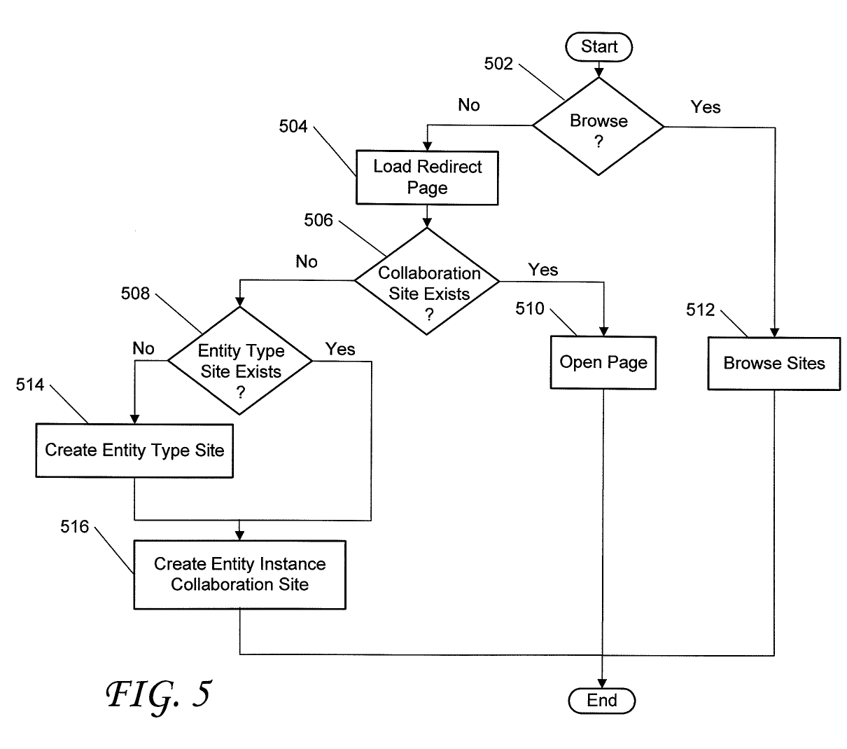

The above structure supports the performance of all necessary operations from a rich client application as well as from the Server 600. Server access is outside the scope of the present disclosure. An overview of access from the rich client is illustrated in FIG. 5. The simplest option is when the user elects at step 502 to browse the sites. They may do this when searching for a site to associate with a document or when looking for information on a particular Entity Instance which would be on the related Entity Instance Collaboration Site 112. Browsing is supported by accessing the Entity Type Mapping Table 108 to review the available Entity Type Sites 106. When the user selects a particular Entity Type the Instance Mapping Table 114 can be used to review the available Entity Instance Collaboration Sites 112. If needed the user can create a new Entity Instance Collaboration Site 112 or Entity Type Site 106 while browsing.

If the user elects direct access at step 502 the next step will always be to Load Redirect Page in step 504. The main function of the Redirect Page 100 is to determine whether the requested Entity Instance Collaboration Site 112 already exists. If this check at step 506 determines that the page already exists, the page will be opened at step 510. Otherwise, an additional check will be performed at step 508 to determine whether the appropriate Entity Type Site 106 already exists. If so, the Entity Instance Collaboration Site 112 will be created at step 516. If the Entity Type Site 106 does not yet exist, it will be created at step 514 prior to creating the Entity Instance Collaboration Site 112. As part of the creation of each type of site, the necessary information will be obtained from the user and the corresponding entry created in the appropriate mapping table. An exemplary embodiment also allows workflows to be defined which execute during site creation. These workflows can then create and initialize additional components or functionality to be added to the site.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A computer-based system of collaboration sites comprising:
(a) a collaboration root;
(b) a plurality of entity type sites logically connected as sub-sites to the collaboration root; and
(c) a plurality of entity instance collaboration sites, each logically connected as a sub-site to a one of the entity type sites.

2. The computer-based system of claim 1 further comprising a redirection page logically connected to the collaboration root.

3. The computer-based system of claim 1 further comprising an entity type mapping table which associates each of the entity type sites with a logical address.

4. The computer-based system of claim 3 further comprising an instance mapping table which associates each of the entity instance collaboration sites with its logical address.

5. The computer-based system of claim 1 further comprising a plurality of client application documents, each of the client application documents comprising a persistent data, the persistent data comprising a logical address of an associated entity instance collaboration site.

6. The computer-based system of claim 1 wherein a first entity instance collaboration site is associated with a second entity type site.

7. The computer-based system of claim 6 wherein the first entity instance collaboration site is further associated with specific entity instance collaboration sites which are sub-sites to the second entity type site.

8. A method of maintaining logical entity instance collaboration sites in a computer-based system comprising:
(a) providing a collaboration root site;
(b) providing a redirect page logically connected to the collaboration root site;
(c) directing all requests to access an entity instance collaboration site to the redirect page;
(d) the redirect page responsive to a request to access the entity instance collaboration site by:
(i) determining whether the entity instance collaboration site for which access was requested already exists;
(ii) if the entity instance collaboration site exists, determining a logical address of the entity instance collaboration site and providing the logical address to the request; and
(iii) if the entity instance collaboration site does not exist, creating the entity instance collaboration site with the logical address and providing the logical address of a new page to the request.

9. The method of claim 8 further comprising:
providing a plurality of entity type sites logically connected as sub-sites to the collaboration root site;
wherein each of the entity instance collaboration sites is logically connected as a sub-site to one of the entity type sites, and further wherein the step of creating the entity instance collaboration site further comprises determining whether an appropriate entity type site already exists and creating the entity type site if it does not exist.

10. The method of claim 9 further comprising providing an instance mapping table which associates each of the entity instance collaboration sites with its logical address and wherein the step of determining whether the entity instance collaboration site exists comprises attempting to retrieve the logical address of the entity instance collaboration site from the instance mapping table.

11. The method of claim 10 further comprising providing an entity type mapping table which associates each of the entity type sites with its logical address and wherein the step of determining whether the appropriate entity type site exists comprises attempting to retrieve the logical address of the entity type site from the entity type mapping table.

12. The method of claim 11 further comprising providing a client application having an ability to create a client item and providing a capability to specify the logical address of the entity instance collaboration site and have the logical address stored in association with the client item.

13. The method of claim 11 wherein the step of specifying the logical address of the entity instance collaboration site comprises browsing the entity instance collaboration sites available and selecting one.

14. The method of claim 13 further comprising creating a new entity instance collaboration site and selecting the new entity instance collaboration site.

15. The method of claim 13 wherein the step of specifying the logical address of the entity instance collaboration site comprises first browsing the set of entity type sites available, selecting an entity type site, and then restricting the set of entity instance collaboration sites presented for browsing to those entity instance collaboration sites logically connected to the entity type site selected as a sub-site.

16. The method of claim 15 wherein browsing the entity type sites available further comprises creating a new entity type site and making it available to be selected.

17. A computer-based system of collaboration sites comprising:
(e) a collaboration root;
(f) a plurality of entity type sites logically connected as sub-sites to the collaboration root, each of the entity type sites having a logical address;
(g) a plurality of entity instance collaboration sites, each logically connected as a sub-site to one of the entity type sites, each of the entity instance collaboration sites having a logical address;
(h) a redirection page logically connected to the collaboration root;
(i) a first mapping table which associates each of the entity type sites with its logical address; and
(j) a second mapping table which associates each of the entity instance collaboration sites with its logical address.

18. The computer-based system of claim 17 wherein a first entity instance collaboration site is associated with a second entity type site.

19. The computer-based system of claim 18 wherein the first entity instance collaboration site is further associated with a second entity instance collaboration site which is the sub-site of the second entity type site.

20. The computer-based system of claim 19 further comprising a plurality client application documents, each of the client application documents comprising persistent data, the persistent data comprising the logical address of an associated entity instance collaboration site.
